(19) United States
(12) Patent Application Publication
(10) Pub. No.: US 2010/0211976 A1
(43) Pub. Date: Aug. 19, 2010

(54) MULTIMEDIA FILE SHARING METHOD AND SYSTEM

(75) Inventors: Kuo-Chung Chiu, Taipei (TW); Yang-Po Chiu, Taipei (TW); Yi-Hsou Lee, Taipei (TW)

Correspondence Address: KIRTON AND MCCONKIE, 60 EAST SOUTH TEMPLE,, SUITE 1800, SALT LAKE CITY, UT, 84111, US

(73) Assignee: ASUSTEK COMPUTER INC., Taipei (TW)

(21) Appl. No.: 12/690,277

(22) Filed: Jan. 20, 2010

(30) Foreign Application Priority Data
Feb. 17, 2009 (TW) 098104952

(51) Int. Cl. G06F 17/30; H04N 5/445

(52) U.S. Cl. 725/53; 707/769; 707/E17.014; 707/E17.009; 707/E17.005

(57) ABSTRACT

The invention discloses a multimedia file sharing method and system used in a network. The system includes a first user device, a server and a second user device. The method includes the following steps. The first user device receives a multimedia data from a multimedia source, converts the multimedia data to the multimedia file and stores it. The first user device transmits information of the multimedia file including a characteristic of the multimedia file and an IP address of the first user device to the database of a server to be stored. When the second user device sends a file searching request and searches the database of the server, it obtains a file searching result including the information of the multimedia file and transmits the file searching result to the second user device. The second user device downloads the multimedia file from the first user device according to the information of the multimedia file.

### FIELD OF THE INVENTION

The invention provides a multimedia file sharing method and system and, more particularly, to a multimedia file sharing method and system used in a network.

### BACKGROUND OF THE INVENTION

Modern people are busy nowadays, and they're not often watch TV programs on time at home and miss their preferred TV programs. Therefore, it is necessary to provide a solution for people to watch the program after its' broadcasting time. There are two common resolutions, one is to record the programs in advance using various recording devices, and the other one resolution, is to watch a missed program via a video on demand (VOD) system. For example, when a user knows that he or she may miss a live broadcast of the opening ceremony of the Olympic Games, he or she may set the recording time of the recording device, and enjoy the program at leisure. However, when the user fails to watch a program on time due to an unexpected event, he or she cannot set the schedule recording beforehand. Then, the VOD system is the only choice to watch it. However, if the television station does not provide the VOD system, the user can do nothing but regret. Thus, how to improve the technology is the main objective of the invention.

### SUMMARY OF THE INVENTION

The invention provides a multimedia file sharing method, used between a plurality of user devices and a server which are connected through a network. The method includes following steps. A first user device of the user devices receives a multimedia data from a multimedia data source, converts the multimedia data to a multimedia file and stores the multimedia file. The first user device transmits information of the multimedia file including a characteristic of the multimedia file and an IP address of the first user device to a database of the server. The database in the server is searched according to a file searching request sent by a second user device of the user devices. Then, a file searching result including the information of the multimedia file is obtained and transmitted to the second user device. The second user device downloads the multimedia file from the first user device according to the information of the multimedia file in the file searching result.

Moreover, the invention provides a multimedia file sharing system used in a network. The system includes a first user device, a server and a second user device. The first user device is connected to the network and a multimedia data source. The first user device receives a multimedia data from the multimedia data source, converts the multimedia data to a multimedia file, stores the multimedia file and transmits a piece information of the multimedia file and the IP address of the first user device. The server is connected to the network and has a database for storing the information of the multimedia file transmitted from the first user device. The second user device is connected to the network, and it sends a file searching request to the server and searches the database to obtain a file searching result including the information of the multimedia file. Then, the second user device downloads the multimedia file from the first user device according to the information of the multimedia file in the file searching result.

In addition, the invention provides a multimedia file sharing method, used between a plurality of user devices and a server which are connected through a network. Each of the user devices stores a multimedia file having a same format and related with each other. Each of the user devices uploads the information of the multimedia file to a database of the server to be stored. Each of the user devices may be connected to the server to search and connected to other user device to download the multimedia file directly according to a result transmitted from the server. The multimedia file sharing method includes the following steps. The characteristic of a multimedia file transmitted by a first user device are received and stored in a database. A file searching request sent by a second user device is received. The database is searched according to the file searching request to obtain a file searching result including the information of the multimedia file. The file searching result is transmitted to the second user device.

### BRIEF DESCRIPTION OF THE DRAWINGS

These and other features, aspects, and advantages of the present invention will become better understood with regard to the following description, appended claims, and accompanying drawings.

FIG. 1 is a functional block diagram showing a multimedia file sharing system according to an embodiment of the invention;

FIG. 2A and FIG. 2B are flow charts showing a multimedia file sharing method according to an embodiment of the invention;

FIG. 3 is a flow chart showing the steps of the time shift in the multimedia file sharing method according to the embodiment of the invention; and

FIG. 4 is a functional block diagram showing the server of a multimedia file sharing system according to a preferred embodiment of the invention.

### DETAILED DESCRIPTION OF THE PREFERRED EMBODIMENT

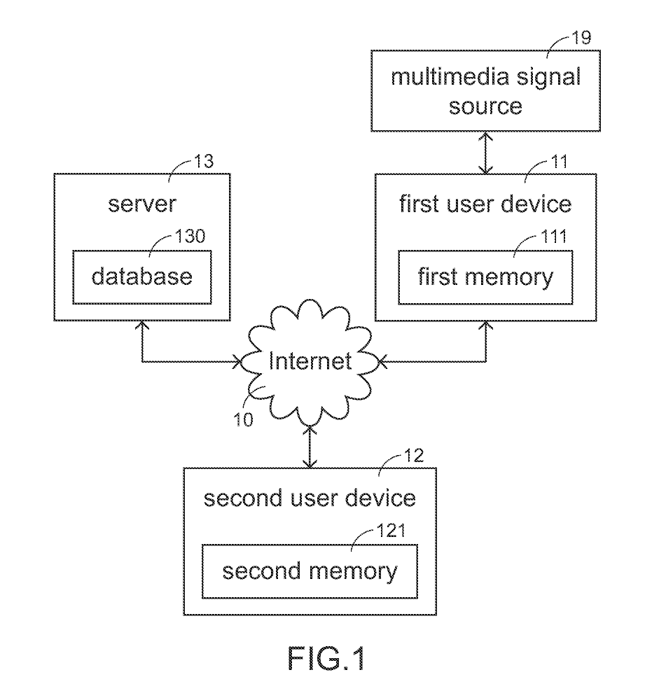

FIG. 1 is a functional block diagram showing a multimedia file sharing system according to an embodiment of the invention. The system is used in the Internet 10, and it mainly includes a plurality of user devices and a server. The user devices may be hardware devices capable of processing multimedia data such as desktop computers, notebook computers or embedded systems.

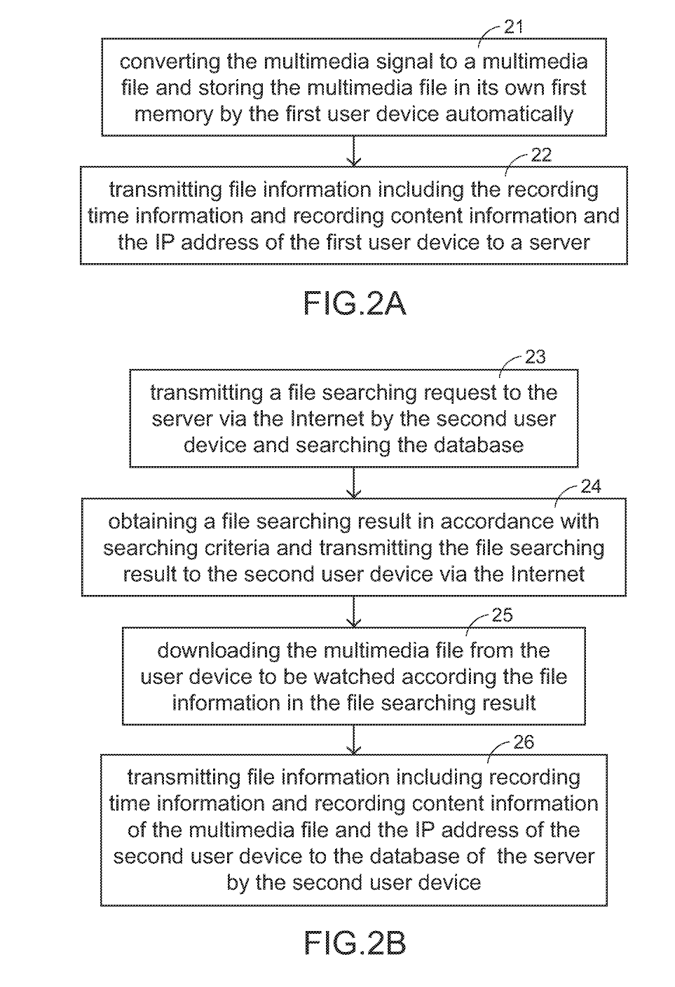

To facilitate the illustration, two user devices are taken as examples in FIG. 1. First, the first user device 11 is connected to the Internet 10 and a multimedia data source 19 which may be a radio station, a radio television station or a cable television station. The first user device 11 may receive a multimedia data from the multimedia data source 19 to broadcast. In broadcasting, the first user device 11 may utilize the flow path shown in FIG. 2A to finish converting the multimedia data to a multimedia file and storing the multimedia file. First, the first user device 11 automatically converts the multimedia data to a multimedia file and the stores the multimedia file in its own first memory 111 (step 21). For example, the first user device 11 may be a personal computer equipped with a television (TV) card, while the multimedia data source is a cable television station. Then, the first user device 11 may choose one channel from a plurality of channels provided by the cable television station to broadcast. For example, the first user device 11 may choose channel ESPN to watch programs, and then it converts the received program signals of the ESPN channel to the multimedia file having recording time information and recording content information and stores the multimedia file in its own first memory 111. Afterward, the first user device 11 transmits a piece of information of the multimedia file having the recording time information, recording content information and the Internet protocol (IP) address of the first user device 11 to a server 13 (step 22). The server 13 is also connected to the Internet 10, and it has a database 130 for storing the information of the multimedia file transmitted by the first user device. In other words, by collecting and receiving information of the multimedia file from the plurality of user devices, the database 130 may store a plurality of pieces of information of the multimedia file transmitted from the plurality of user devices connected with the server 13 via the Internet 10.

Then, when a user using the second user device 12 connected to the Internet 10 wants to watch a missed TV program, he or she may utilize the flow path of a method for searching for a multimedia file as shown in FIG. 2B. First, the second user device 12 sends a file searching request to the server 13 via the Internet 10 and searches the database 130 (step 23). After a file searching result in accordance with the searching criteria (such as the program time information, program content information) is obtained, it is transmitted to the second user device 12 via the Internet 10 (step 24). The file searching result may contain information of the multimedia file. Thus, the second user device 12 knows that the first user device 11 stores the preferred TV program according to the information of the multimedia file in the file searching result. Thus, the multimedia file is downloaded from the first user device 11 to the second user device 12 via the Internet 10 (step 25). The second user device 12 also may have a second memory 121 for storing files and data. The second memory 121 stores the downloaded multimedia file. The second user device 12 may transmit information of the multimedia file having recoding time information and recording content information of the multimedia file and the IP address of the second user device 12 to the database of the server 13 (step 26).

In addition, when the user device (such as a personal computer) converts the multimedia data to a multimedia file and stores the multimedia file in its own memory, it also may divide the multimedia file into a plurality of segments to store it in a plurality of files with less data quantity. For example, a segment with a five minute length may be stored as a file. In addition, when the user device is idle, it may select a channel automatically and randomly to record a program and transmit the information of the multimedia file having the recording time information, recording content information of the multimedia file and the IP address of the user device to the database of the server 13 automatically. Thus, the number of the multimedia files allowable to be downloaded is larger. When the user device cancels certain multimedia file in its own memory, it may transmit a corresponding piece of file cancelling information according to the multimedia file to the database of the server 13 to update the content of the database.

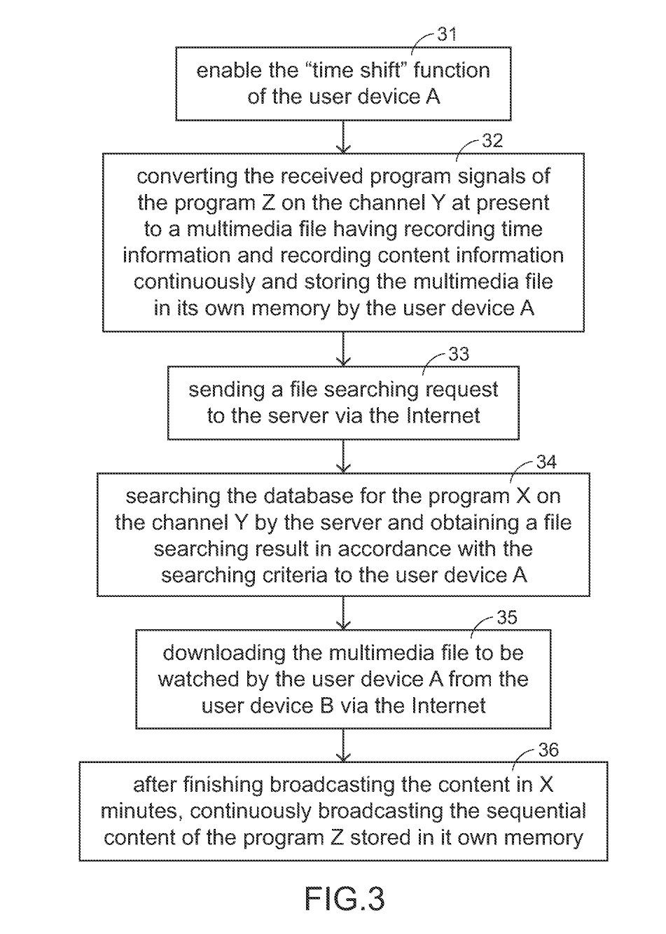

As stated above, the user device may perform the function such as the time shift, and the flow path of the method thereof is shown in FIG. 3. For example, when the user misses the program Z on the channel Y for X minutes, the “time shift” function of the user device A may be performed (step 31). Thus, the user device A converts the received program signals of the program Z on the channel Y to the multimedia file having the recording time information and the recording content information continuously and stores the multimedia file in its own memory (step 32). On the other hand, the user device A sends a file searching request to the server 13 via the Internet (step 33). Then, the server 13 searches for the program Z on the channel Y in the database 130 and obtains and transmits a file searching result in accordance with the searching criterion (contents in preceding X minutes of Z program on the channel Y) to the user device A (step 34). Then, the user device A knows that the user device B stores the contents in preceding X minutes of Z program on the channel Y according to the information of the multimedia file in the file searching result. Then, the user device A may download the multimedia file to watch from the user device B via the Internet (step 35). After finishing broadcasting the contents in preceding X minutes, the user device A continuously broadcast the sequential content of the program Z stored in the own memory (step 36).

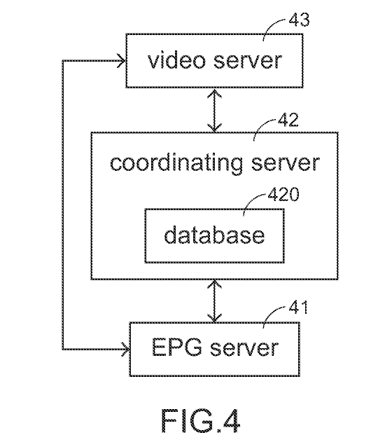

FIG. 4 is a functional block diagram showing a server according a preferred embodiment of the invention. The server is composed of an electronic program guide (EPG) server 41, a coordinating server 42 and a video server 43. The EPG server 41 stores EPG of various television stations which are updated continuously for providing references for the server in the embodiment in searching data. The coordinating server is used to receive information of the multimedia file transmitted from a plurality of user devices and updates the interior database 420 continuously. The video server 43 is used for storing a plurality of multimedia files such as multimedia files of related advertisement of a plurality of sponsors. When the user device is connected to the coordinating server to request the program searching service, the coordinating server may randomly select and transmit one of the advertisement multimedia files to the user device to broadcast. Thus, an advertising effect is realized. The video server 43 may provide video files with other content for the user device to download. Then, the segments of a video file are stored to a plurality of user devices distributedly, and related information is recorded in the coordinating server 42. Moreover, when the coordinating server 42 finds that when a piece of information of the multimedia file in the database 420 is cancelled, no user device would store the corresponding multimedia file, the coordinating server 42 back up the multimedia file in the video server 42 for a rainy day.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of.

What is claimed is:

1. A multimedia file sharing method, used between a plurality of user devices and a server connected through a network, the method comprising the steps of:
receiving a multimedia data from a multimedia data source, converting the multimedia data to a multimedia file and storing the multimedia file by a first user device of the user devices;
transmitting a piece of information of the multimedia file having a characteristic of the multimedia file and an Internet protocol (IP) address of the first user device to a database of the server by the first user device;
searching the database of the server according to a file searching request sent by a second user device of the user devices to obtain a file searching result having the information of the multimedia file and transmit the file searching result back to the second user device; and
downloading the multimedia file from the first user device according to the information of the multimedia file in the file searching result by the second user device.

2. The multimedia file sharing method according to claim 1, wherein the step of receiving the multimedia data from the multimedia data source, converting the multimedia data to the multimedia file and storing the multimedia file is selecting a channel from a plurality of channels provided by a cable television station to receive a program signal and covert the program signal to the multimedia file, and store the multimedia file.

3. The multimedia file sharing method according to claim 1, wherein the characteristic of the multimedia file in the information of the multimedia file transmitted by the first user device is recording time information and a recording content information.

4. The multimedia file sharing method according to claim 1, wherein the second user device transmits information of the multimedia file including the characteristic of the multimedia file and an IP address of the second user device to the database of the server to be stored after the second user device downloads the multimedia file from the first user device according to the information of the multimedia file in the file searching result and stores the multimedia file.

5. The multimedia file sharing method according to claim 1, wherein the multimedia file is divided into a plurality of segments to be stored in files with less data quantity.

6. The multimedia file sharing method according to claim 1 wherein when the first user device or the second user device is in idle, the first user device or the second user device selects a channel to record programs automatically and randomly and transmits information of the multimedia file including recoding time information and recoding content information of the multimedia file and an IP address of the user device to the database of the server automatically.

7. The multimedia file sharing method according to claim 1, wherein when the user device cancels a multimedia file in an own memory, the user device transmits a piece of file cancelling information corresponding to the multimedia file to the database of the server to update the content of the database.

8. The multimedia file sharing method according to claim 1, wherein when the second user device downloads a first portion of the multimedia file from the first user device according to the information of the multimedia file in the file researching result, the method further comprises the steps of:
receiving the multimedia data from the multimedia data source, converting the multimedia data to a second portion of the multimedia file, and storing the second portion by the second user device; and
broadcasting the second portion of the multimedia file continuously by the second user device after finishing broadcasting the first portion of the multimedia file.

9. A multimedia file sharing system, used in a network, the system comprising:
a first user device connected to the network and a multimedia data source, wherein the first user device receives a multimedia data from the multimedia data source, converts the multimedia data to a multimedia file, stores the multimedia file, and transmits a piece of information of the multimedia file including the multimedia file and an IP address of the first user device;
a server connected to the network, wherein the server has a database for storing the information of the multimedia file transmitted by the first user device; and
a second user device connected to the network, wherein the second user device sends a file searching request to the server to search the database to obtain a file searching result including the information of the multimedia file and downloads the multimedia file from the first user device according to the information of the multimedia file in the file searching result.

10. The multimedia file sharing system according to claim 9, wherein the first user device or the second user device includes a desktop computer, a notebook computer or an embedded system having multimedia processing ability.

11. The multimedia file sharing system according to claim 10, wherein each of the user devices has a memory for storing the multimedia file.

12. The multimedia file sharing system according to claim 9, wherein the multimedia data source is a radio station, a radio television station or a cable television station.

13. The multimedia file sharing system according to claim 9, wherein the server comprises:
an electronic program guide (EPG) server storing an EPG which is updated continuously for providing references in searching data;
a coordinating server connected to the EPG server and used for receiving a plurality of pieces of information of the multimedia file transmitted from the plurality of user devices and storing the information of the multimedia file in the database; and
a video server connected to the coordinating server and used for storing a plurality of multimedia files, wherein when a user device is connected to the coordinating server to request a program searching service, the coordinating server selects and transmits one of the plurality of the multimedia files in the video server to the user device to broadcast.

14. The multimedia file sharing system according to claim 13, wherein when the coordinating server finds that if a piece of information of the multimedia file in the database is cancelled, no user device stores a multimedia file corresponding to the information of the multimedia file, the multimedia file is backed up in the video server.

15. The multimedia file sharing system according to the claim 9, wherein after the second user device downloads the multimedia file from the first user device and stores the multimedia file according to the information of the multimedia file in the file searching result, the second user device transmits information of the multimedia file including a characteristic of the multimedia file and an IP address of the second user device to the database of the server to be stored.

16. The multimedia file sharing system according to claim 9, wherein the multimedia file is divided into a plurality of segments to be stored in a plurality of files with less data quantity.

17. The multimedia file sharing system according to claim 9, wherein when the first user device or the second user device is idle, the first user device or the second user device selects a channel to record programs automatically and randomly and transmits information of the multimedia file including recording time information and recording content information of the multimedia file and an IP address of the user device to the database of the server.

18. The multimedia file sharing system according to claim 9, wherein when the user device cancels a multimedia file in an own memory, the user device transmits a piece of file cancelling information corresponding to the multimedia file to the database of the server automatically to update the content of the database.

19. A multimedia file sharing method, used between a plurality user devices and a server which are connected through a network, wherein each of the user devices stores a multimedia file having a same format and related to each other, each of the user devices transmits information of the multimedia file to a database of the server to be stored, and each of the user devices is capable of being connected to the server to search and directly being connected to other user devices to download the multimedia file according to a result transmitted by the server, the multimedia file sharing method comprising the steps of:
receiving a characteristic of multimedia file transmitted by a first user device and storing the characteristic in a database;
receiving a file searching request sent by a second user device;
searching the database according to the file searching request to obtain a file searching result including the information of the multimedia file; and
transmitting the file searching result to the second user device.

20. The multimedia file sharing method according to claim 19, wherein the characteristic of the multimedia file in the information of the multimedia file transmitted by the first user device is recording time information and recording content information, and the file searching request sent by the second user device comprises searching criteria composed of program time information program content information.
